(19) United States
(12) Patent Application Publication
(10) Pub. No.: US 2016/0331195 A1
(43) Pub. Date: Nov. 17, 2016

(54) TOILET SEAT WITH PEEL-OFF LAYERS

(71) Applicant: Nazar Navolskyy, Woodbridge (CA)

(72) Inventor: Nazar Navolskyy, Woodbridge (CA)

(21) Appl. No.: 15/153,862

(22) Filed: May 13, 2016

Related U.S. Application Data
(60) Provisional application No. 62/161,390, filed on May 14, 2015.

(51) Int. Cl. A47K 13/22; B32B 3/26; B32B 7/06; B32B 3/06; E03D 11/02; A47K 13/04

(52) U.S. Cl. CPC A47K 13/225; E03D 11/02; A47K 13/04; B32B 7/06; B32B 3/06; B32B 3/266; B32B 2432/00; B32B 2479/00

(57) ABSTRACT

A toilet includes a toilet unit and a toilet seat system. The toilet includes a lower bowl, the lower bowl having an upper support surface defining an upper opening sized to receive human waste from a user seated over the upper opening. The toilet seat system includes a base and a cartridge. The base overlies the upper support surface and is fastened to the toilet unit. The cartridge is removably connected to the base. The cartridge includes a plurality of peel-off seating layers, each peel-off seating layer being independently separable from the other peel-off seating layers for disposal, each peel-off seating layer including an outwardly extending removal tab, and each peel-off seating layer including an upper seating surface sized to support a user seated over the upper opening.

### RELATED APPLICATIONS

The application claims priority from the U.S. patent application Ser. No. 62/161,390, filed May 14, 2015 entitled “TOILET SEAT WITH PEEL-OFF LAYERS”, the disclosures of which are incorporated herein, in its entirety, by reference.

### FIELD

The present invention relates generally to providing sanitary peel-off layers to a toilet seat.

### BACKGROUND

Toilet units having features to improve sanitary conditions for the users of the toilet units are known.

### SUMMARY

In accordance with an embodiment of the invention, there is provided a replacement toilet seat system that replaces the regular toilet seat of a toilet unit. In another embodiment, there is provided a toilet seat attachment that attaches to the regular toilet seat of a toilet unit. Each of the replacement toilet seat system and the toilet seat attachment comprises a disposable cartridge element having sanitary peel-off layers.

In both these embodiments, when all the disposable “peel-off” layers of the cartridge element are exhausted, the disposable cartridge element may be replaced.

In one embodiment, a toilet seat attachment having a disposable cartridge element may be attached to the regular toilet seat of the toilet unit with an adhesive. In another embodiment, the cartridge element of the toilet seat attachment may comprise one or more fastener elements that facilitate the attachment of the cartridge element to the regular toilet seat.

A preferred embodiment of the toilet seat attachment may comprise a base element in addition to the cartridge element. In this embodiment, the base element attaches to the regular toilet seat to provide an improved base surface to support and secure the disposable cartridge element having multiple “peel-off” layers.

An embodiment of the replacement toilet seat system may comprise a base element in addition to the cartridge element, where the base element replaces the regular toilet seat.

In some embodiments, when the base element and the cartridge element are attached, the base element surface and the cartridge element surface may cooperate to provide a number of positive benefits, such as, resistance to sliding or displacement of the cartridge element vis-à-vis the base element.

Complimentary base element and cartridge element surfaces may also provide a “single way” to attach the cartridge element to the base element, resulting in less room for error and a quicker replacement process for the individual replacing the cartridge element. The complementary surfaces may also be designed to guide the two surfaces to “find” the optimal contact regions vis-à-vis the other surface, starting at an initial sub-optimal contact position.

The base element surface and the cartridge element surface may also comprise a locking mechanism to further secure the base element to the cartridge element. Such a locking mechanism may engage a lock between the base element and the cartridge element, for example, when the cartridge element is pushed down into the base element.

In one aspect, a toilet is provided. The toilet may include a toilet unit and a toilet seat system. The toilet may have a lower bowl, and the lower bowl may have an upper support surface defining an upper opening sized to receive human waste from a user seated over the upper opening. The toilet seat system may include a base overlying the upper support surface and fastened to the toilet unit, and a cartridge removably connected to the base. The cartridge may include a plurality of peel-off seating layers. Each peel-off seating layer may be independently separable from the other peel-off seating layers for disposal, each peel-off seating layer may include an outwardly extending removal tab, and each peel-off seating layer may include an upper seating surface sized to support a user seated over the upper opening.

In some embodiments, the cartridge may overlie the base, and the cartridge is held spaced apart from the lower bowl by the base.

In some embodiments, the base may have a base upper surface, and the cartridge may overlie the entirety of the base upper surface.

In some embodiments, the base may include a lock that removably connects the cartridge to the base, and the lock may have a locked position in which the cartridge is secured to the base, and an unlocked position in which the cartridge is removable from the base.

In some embodiments, the base may include a base upper surface having at least one of a base groove or a base ridge, and the cartridge may include a cartridge lower surface having at least one of a cartridge groove or a cartridge ridge that mates with the base ridge or base groove when the cartridge is connected to the base.

In some embodiments, the base may be supported on the upper support surface.

In some embodiments, the toilet unit may further comprise a toilet seat overlying the upper support surface, and the base may be supported on the toilet seat.

In some embodiments, the base may include at least one fastener connecting the base to the toilet seat.

In some embodiments, the at least one fastener may include adhesive.

In another aspect, a toilet seat system for a toilet unit is provided. The toilet unit may have a lower bowl, the lower bowl having an upper support surface defining an upper opening sized to receive human waste from a user seated over the upper opening. The toilet system may include a base sized to overlie the upper support surface of the lower bowl of the toilet unit, and a cartridge removably connected to the base. The cartridge may include a plurality of peel-off seating layers. Each peel-off seating layer may be independently separable from the other peel-off seating layers for disposal, each peel-off seating layer may include an outwardly extending removal tab, and each peel-off seating layer may include an upper seating surface sized to support a user seated over the upper opening of the lower bowl of the toilet unit. The base and cartridge may define a passage for human waste from a user seated on a peel-off seating layer into the lower bowl of the toilet unit.

In some embodiments, the base may have a base upper surface, and the cartridge overlies the entirety of the base upper surface.

In some embodiments, the base may include a lock that removably connects the cartridge to the base, and the lock may have a locked position in which the cartridge is secured to the base, and an unlocked position in which the cartridge is removable from the base.

In some embodiments, the base may include a base upper surface having at least one of a base groove or a base ridge, and the cartridge may include a cartridge lower surface having at least one of a cartridge groove or a cartridge ridge that mates with the base ridge or base groove when the cartridge is connected to the base.

In another aspect, a method of sanitizing a toilet is provided. The method includes connecting a cartridge to a base, the cartridge including a plurality of peel-off seating layers, each peel-off seating layer independently separable from the other peel-off seating layers for disposal, each peel-off seating layer including an outwardly extending removal tab, the base connected to a toilet unit over an upper opening of a lower bowl of the toilet unit; and pulling the removal tab to remove a topmost peel-off seating layer of the plurality of peel-off seating layers from the cartridge.

In some embodiments, connecting the cartridge to the base includes mating a base groove or base ridge with a cartridge ridge or cartridge groove.

In some embodiments, the method may further include removing the cartridge from the base, and replacing the cartridge with a new cartridge having a plurality of peel-off seating layers, each peel-off seating layer independently separable from the other peel-off seating layers for disposal, each peel-off seating layer including an outwardly extending removal tab.

In some embodiments, removing the cartridge from the base may include moving a lock to an unlocked position to release the cartridge from the base.

In some embodiments, the base may be fastened to a toilet seat overlying the upper opening.

### BRIEF DESCRIPTION OF THE DRAWINGS

The features of the invention will become more apparent in the following detailed description in which reference is made to the appended drawings wherein:

FIG. 1 is a perspective view of a replacement toilet seat system in accordance with an embodiment;

FIG. 2 is an exploded view of a toilet seat attachment in accordance with an embodiment;

FIG. 3 is an exploded view of the replacement toilet seat system of FIG. 1; and

FIG. 4 is an exploded view of a toilet seat attachment in accordance with another embodiment.

### DETAILED DESCRIPTION

Various apparatuses or processes will be described below in relation to a replacement toilet seat system and/or a toilet seat attachment having a cartridge element with peel-off layers. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Moreover, the title headings in the description below are present only for organizational purposes to help the reader, and not to limit aspects of the invention to a particular class of embodiments. Therefore, notwithstanding the presence of the title headings, any of the features under one title heading may be combined with the features under a different title heading, as long as the features are not mutually incompatible.

Improved toilet units can be used in a variety of residential and commercial settings. A toilet unit may have multiple users, and after the toilet unit is used by a particular user, it may not be in a suitable sanitary condition to be utilized by another user. Further, it may be impractical to manually clean the toilet unit each time the toilet unit is used and/or prior to the use of the toilet unit by a different user. In such instances, the subsequent users of the toilet unit may experience undesirable sanitary conditions when using the toilet unit.

A user of the toilet unit may come into physical contact with the toilet unit and the surrounding environment in a variety of means. For example, when the user enters the toilet stall containing a toilet unit, the user's footwear (or bare feet) may come into contact with the floor surface in the stall. When the user attempts to obtain toilet paper, the user's hands may come into contact with the toilet paper dispenser. Moreover, relevant to this application, if the user needs to sit down on the toilet unit, the user's skin may make direct contact with the toilet seat of the toilet unit.

To reduce the likelihood that bacteria, viruses, and other undesirable pathogens do not transfer from the toilet seat to the skin of the user, some users place one or more layers of toilet paper on the toilet seat before sitting down on the toilet unit. Such an approach may unnecessarily waste toilet paper, result in stray toilet paper on the floor that can increase labor costs in cleaning the washroom, and/or increase the frequency of clogging of the toilet unit if significant amount of toilet paper is used. Some toilet paper dispensers also make it very difficult to obtain toilet paper before the user has actually sat down on the toilet seat. Moreover, some toilet paper is very narrow in width, making it unsuitable for easily covering a toilet seat surface.

It should be noted that some washrooms also provide disposable toilet seat covers that can be placed on the toilet seat by a user, before the user sits down on the toilet unit. However, for these covers to be effective, the user may need to spend time to prepare and place the cover correctly on the toilet seat. Moreover, such disposable toilet seat covers may change position if the user gets up briefly from the toilet seat, and may tend to slide relative to the toilet seat.

In addition or alternatively to the above, to minimize undesirable skin contact with the toilet unit, some users may also “stand” on the toilet seat in a crouching position (to simulate the usage of a “squat toilet”), instead of sitting on the toilet seat. Clearly, this is not desirable for a variety of reasons and should be discouraged by making available features that facilitate superior sanitary conditions.

Therefore, broadly speaking, the issues related to the usage of the toilet unit may generally fall into one or more of the following categories: 1) sanitary conditions, 2) ease of use by the user of the toilet unit, 3) ease of maintenance by the staff, and 4) cost related considerations.

The embodiments described herein generally describe toilet seat structures (e.g. a replacement toilet seat system or a toilet seat attachment), each having a disposable cartridge element that includes sanitary peel-off layers, which may alleviate one or more of the above issues.

Moreover, a preferred embodiment of a toilet seat structure may comprise elements that can facilitate the proper positioning of the toilet seat structure vis-à-vis the toilet unit, or the proper positioning of a component of the toilet seat structure vis-à-vis another component of the toilet seat structure. This can be desirable as it may reduce the likelihood of improper positioning of the toilet seat structure by a maintenance staff member when performing installation and/or maintenance functions.

Such improper positioning may have undesirable consequences, for example, by reducing the degree of support provided to a user sitting on the toilet unit. Additionally, to ensure that each layer of the cartridge element covers the full sitting surface as intended, if there can be variability in the positioning of the cartridge element, each “peel-off” layer may need to be manufactured to have a larger surface area than strictly necessary to cover the desired surface area.

It may also be beneficial if the attachment between the replacement toilet seat system and the toilet unit, the toilet seat attachment and the regular toilet seat, and/or the cartridge element and the base element (if present) are secure. Otherwise, one or more of these components may change position or shift from the original position as originally attached, depending on the usage habits of the previous users. This may require the subsequent user or the maintenance staff member to readjust the position as required.

Moreover, a maintenance staff member may need to clean the toilet unit on a particular maintenance schedule. In the event that the cartridge element still has usable layers, which may be negatively affected by cleaning agents and water, the cartridge element may need to be “removed” and then “reattached” after the cleaning is completed. In preferred embodiments, the cartridge element may be attachable a plurality of times, without resulting in a weaker attachment on each subsequent re-attachment of the disposable cartridge element.

### Disposable Cartridge Element

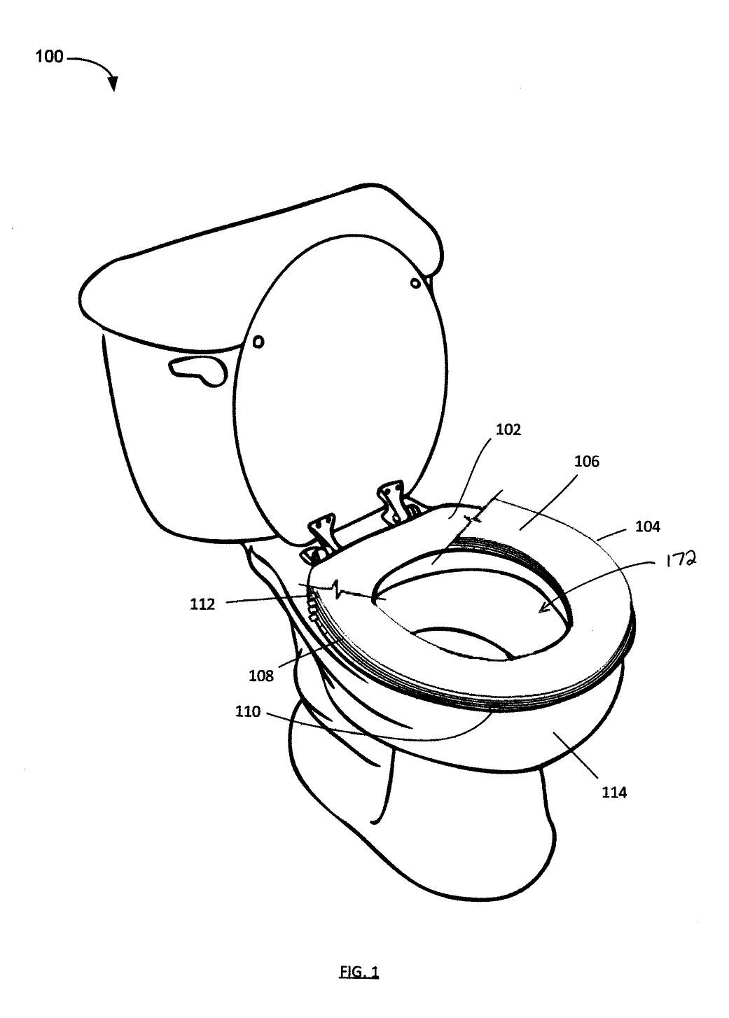

Referring to FIG. 1, the disposable cartridge element 104 of the replacement toilet seat system 100 may have multiple sanitary peel-off layers (e.g. 150 plastic layers), and each layer may be peeled-off independently of the other layers. Prior to using the toilet unit, the user would peel-off the top “dirty” layer 106 to obtain a new “clean” layer 108. Depending on the material of each peel-off layer, the top layer that is peeled-off may be flushed down the toilet or may be disposed of by some other means (e.g. thrown into a garbage receptacle).

Each peel-off layer may also have a “tab” 112 to allow a user to minimize contact with the central part of the top “dirty” layer when peeling-off this layer. Alternatively, or in combination, there may also be a “peeler” unit that the user may utilize to peel-off the top “dirty” layer, without having to physically touch any of the peel-off layers. In some embodiments, such a “peeler” unit may be a type of scraper that can “scrape off” the top layer.

When all the disposable “peel off” layers are exhausted, the cartridge element may be replaced.

A disposable cartridge element of a toilet seat attachment may have substantially the same properties.

### Toilet Seat Attachment Without Base Element

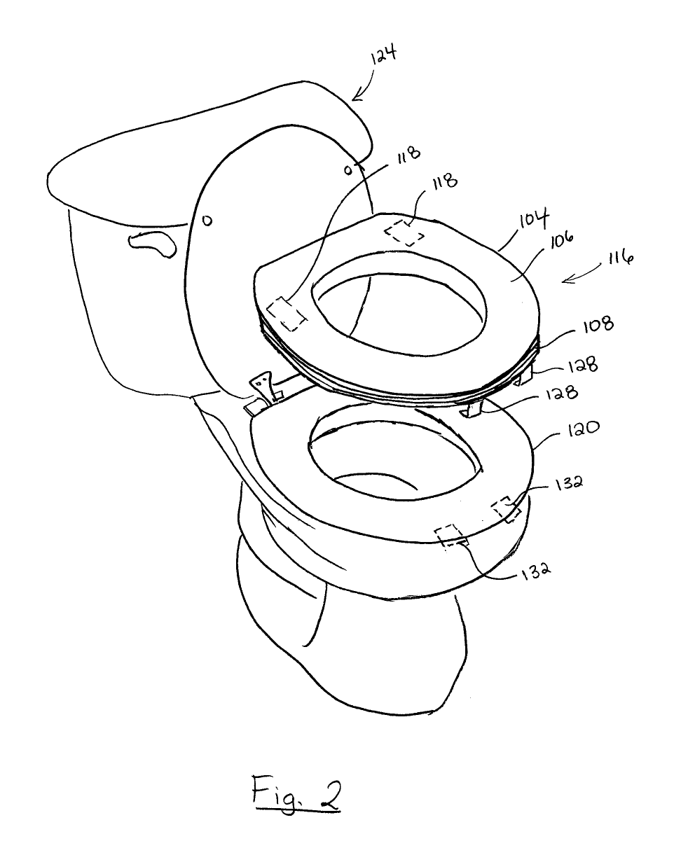

Referring to FIG. 2, in one embodiment, a toilet seat attachment 116 comprising a disposable cartridge element 104 may be attached to the regular toilet seat 120 of the toilet unit 124 with an adhesive 118, such as double-sided tape or glue. Here, the term “regular toilet seat” refers to the existing toilet seat 120 of the toilet unit 124, prior to the attachment of the toilet seat attachment 116 to the toilet unit 124. Such a regular toilet seat 120 may be the original toilet seat that came with the toilet unit or a replacement toilet seat that may be substantially similar to the original toilet seat.

Once attached to the regular toilet seat, the disposable cartridge element 104 may improve the sanitary conditions for a user of the toilet unit 124, since the user may peel off the top layer 106 of the disposable cartridge element 104 to obtain a new “clean” layer 108.

In a preferred embodiment, a toilet seat attachment having a cartridge element 104 may comprise a non-adhesive fastener element 128 that is attachable to a regular toilet seat 120. For example, such a fastener element 128 may “clip” on to the regular toilet seat 120, and fasten the cartridge element 104 to the regular toilet seat 120 at one or more fastening regions 132.

To improve stability, another preferred embodiment may have a plurality of such fastener elements 132, in order to create a plurality of fastening regions 132 where the cartridge element 104 is securely attached to the regular toilet seat 120.

Toilet Seat Attachment with Base Element

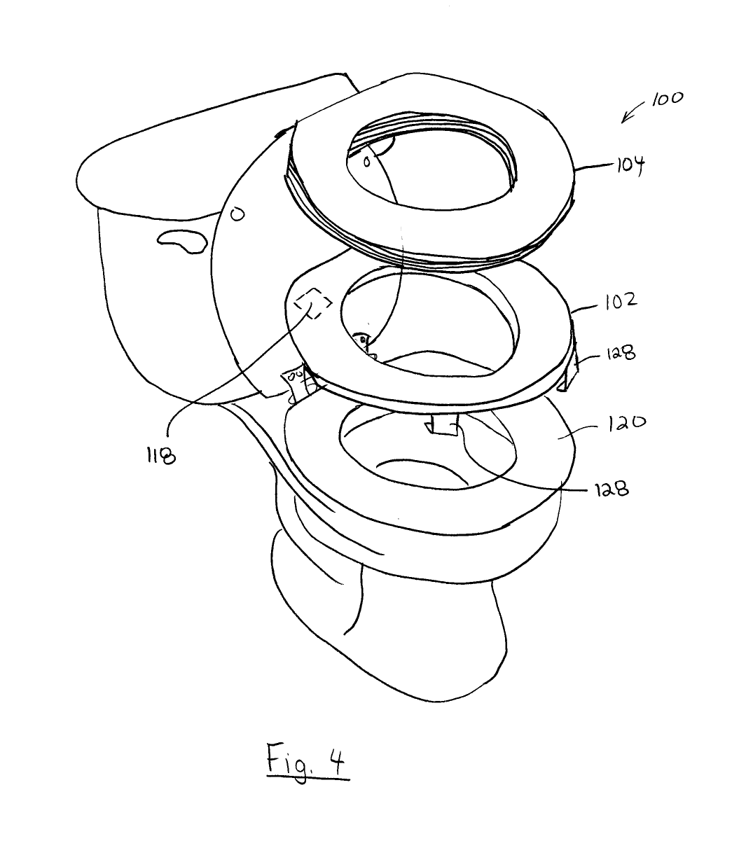

Referring to FIG. 4, a preferred embodiment of a toilet seat attachment 100 may comprise a base element 102 in addition to the cartridge element 104. In this embodiment, instead of the cartridge element 104 attaching directly to the regular toilet seat 120, the base element 104 attaches to the regular toilet seat 120 (e.g. by fasteners 118 and/or 128) to provide an improved base surface 136 to the cartridge element 104. Compared to attaching the cartridge element 104 directly to the regular toilet seat 120, having this “intermediate” base element layer 102 may be advantageous in some respects, as the attachment between the base element 102 and the regular toilet seat 120 can be made to be stronger and/or more secure than an attachment between a disposable cartridge element 104 and a regular toilet seat 120. With such a secure base element 102 in place, an appropriate design may ensure that the cartridge element 104 attaches to the base element 102 securely, while being easily attachable/detachable.

In a nutshell, for the same ease of attachability and detachability of the disposable cartridge element 104, the attachment between the cartridge element 104 and the base element 102 and the attachment between the base element 102 and the regular toilet seat 120, may be individually and in combination, be more secure than a single attachment between the disposable cartridge 104 element and the regular toilet seat 120.

### Replacement Toilet Seat System—Base Element Replaces Regular Toilet Seat

Referring to FIG. 1, an embodiment of a replacement toilet seat system may comprise a base element 102 in addition to the cartridge element 104, where the base element 102 replaces the regular toilet seat of the toilet unit. In such embodiments, an installer and/or a maintenance staff member may remove the regular toilet seat from the toilet unit and install the base element 102 in its place. In some embodiments, the cartridge element 104 comprising the plurality of sanitary peel-off layers may cover the entirety of the base element 102. FIG. 1 illustrates one such embodiment: the cutaway lines located towards the back of the cartridge element 104 are only present to more clearly illustrate the base element 102.

Once the base element 102 is installed on the toilet unit (replacing the regular toilet seat), the cartridge element 104 may be attached to the base element 102, where the cartridge element 104 provides the desirable “peel-off” layers.

Such a base element 102 may substantially cover the surface area previously covered by the regular toilet seat, such that the base element 102 supports the cartridge element 104 above the toilet bowl 114, so that the cartridge element 104 is not in contact with the toilet bowl 114. Alternatively, the base element may have one or more support elements, not necessarily covering the surface area previously covered by the regular toilet seat, but that can still ensure that the cartridge element is not in contact with the toilet bowl.

In another embodiment, the base element may simply be an adapter that connects to the toilet bowl that facilitates efficient attachment/detachment of the cartridge element. In such an embodiment, the cartridge element may be in direct contact with the toilet bowl, and the necessary seating support for a user of the toilet may be substantially provided by the combination of the cartridge element and the toilet bowl.

When all the disposable “peel off” layers of the cartridge element are exhausted, the cartridge element itself may be replaced, independent of the base element. That is, the base element may be left in place on top of the toilet bowl.

Visually, the combination of the base element and the disposable cartridge element is designed to appear as a “regular” toilet seat to a user from a distance.

### Details of Attachment Between Base Element and Disposable Cartridge Element

With the base element in place, a cartridge element and the base element may cooperate to attach to each other in a fashion that may not be physically possible with a cartridge element attaching directly to a regular toilet seat.

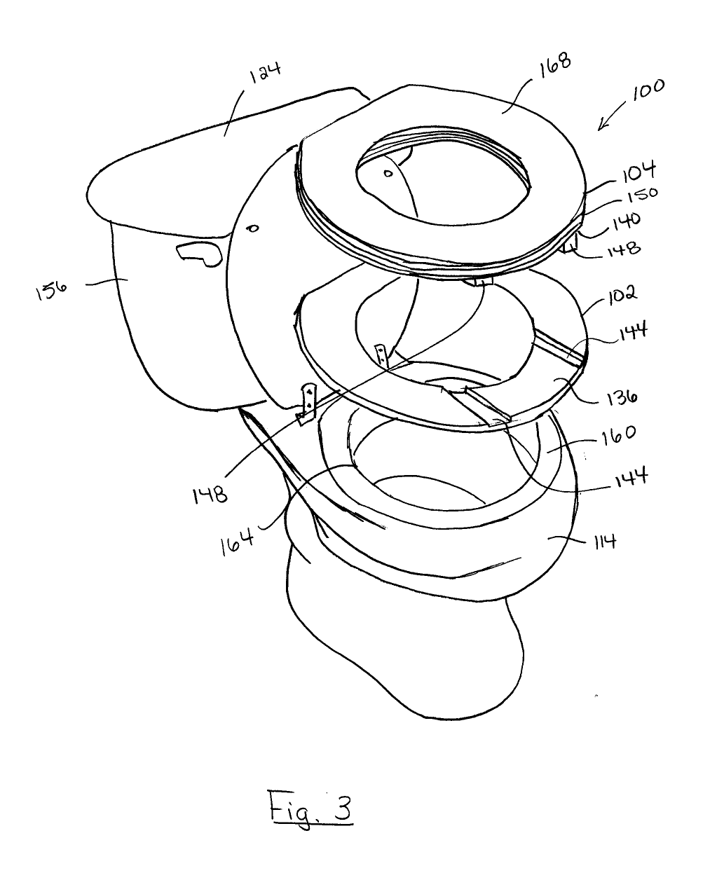

Referring to FIG. 3, the base element 102 may define a base element surface 136 and the cartridge element 104 may define a cartridge element surface 140, such that, the base element surface 136 contacts the cartridge element surface 140 at one or more contact regions in each respective surface.

The two surfaces 136 and 140 may cooperate to provide a number of positive benefits. For example, with an appropriate configuration, the cartridge element 104 may resist sliding or displacement vis-à-vis the base element 102. In some embodiments, there may be grooves 144 in the base element 102 and complementary ridges 148 on the cartridge element 104 that may fit into these grooves. This may assist the cartridge element 104 to resist sliding or displacement vis-à-vis the base element 102.

Such an embodiment may be particularly useful in a male washroom, where a user may desire to raise the toilet seat in some circumstances. If the cartridge element 104 and the base element 102 resist sliding or displacement vis-à-vis each other, a user raising the toilet seat may be less likely to offset the cartridge element 104 vis-à-vis the base element 102 in an undesirable fashion.

The complimentary surfaces 136 and 140 may also provide a “single way” to attach the base element 102 to the cartridge element 104, resulting in less room for error and a quicker replacement process for the individual replacing the cartridge element 104. The complementary surfaces 136 and 140 may also be designed to guide the two surfaces 136 and 140 to “find” the optimal contact regions vis-à-vis the other surface, starting at an initial sub-optimal contact position. For example, the base element 102 may have grooves 144 in an inclined shape, such that, when the maintenance staff member places the cartridge element 104 in a sub-optimal position vis-à-vis the base element (i.e. not exactly aligning the grooves 144 of the base element 102 with the ridges 148 on the cartridge element 104), the cartridge element 104 may “slide” into the optimal position.

Further to the complimentary shapes of the base element surface and the cartridge element surface, an embodiment may also have a locking mechanism to further secure the base element to the cartridge element. Such a locking mechanism may engage a lock between the base element and the cartridge element, for example, when the cartridge element is pushed down into the base element.

For example, referring to FIG. 1, the base element 102 may comprise a plurality of lock elements 110 that securely attach the cartridge element to the base element. In this embodiment, each of the base element surface and the cartridge element surface may be relatively flat without any grooves or ridges, but are secured to each other with the lock elements 110 of base element 102. A maintenance staff member that wishes to replace the cartridge element may have to unlock the lock elements 110 before lifting up the cartridge element.

In another embodiment, the one or more lock elements of the base element may be exclusively present to the rear of the base element, where the rear end of the cartridge element may be pivotably attached to the one or more lock elements, such that, the front end of the cartridge element is free to rotate about the one or more lock elements. Once the cartridge element is securely and pivotably attached to the base element via the lock elements, the cartridge element may be pivotably lowered such that the base element surface and the cartridge element surface cooperate to support the cartridge element on the base element.

In some embodiments, when an individual wishes to separate the cartridge element from the base element, the individual may simply press an unlock button (similar to undocking a laptop from a laptop docking station) to disengage the lock between the cartridge element and the base element. Once the lock is disengaged, the individual may simply lift up the cartridge element to completely detach it from the base element.

To be clear, the base element and cartridge element may be securely attached to each other, even without a separate locking mechanism. For example, in some embodiments having grooves and ridges as described above, the grooves on the base element may be oriented such that when the ridges on the cartridge element completely insert into the respective grooves of the base element, the base element and cartridge element become securely attached, such that a threshold force in a particular direction would be required to detach the two elements from each other.

In other embodiments, everything else substantially being the same, the grooves may be on the cartridge element and the ridges may be on the base element. Alternatively, the cartridge element may have some grooves and some ridges, while the base element has the complimentary ridges and grooves to the grooves and ridges present on the cartridge element.

Generally speaking, the “grooves” and the complementary “ridges” of the cartridge element and the base element may be any type of complementary positioning surfaces or components that align and are in contact with one another when the cartridge element and the base element are attached together. Such complementary positioning surfaces or components may have any of the features discussed above in relation to the grooves and the complementary ridges, for example, a “single way” of attachment and sliding into an optimal position.

Still referring to FIG. 3, the toilet unit 124 is shown including an upper bowl 156 and a lower bowl 114. The lower bowl 114 includes an upper support surface 160 that defines an upper opening 164 sized to receive human waste (e.g. urine and feces) from a user seated over the upper opening 164. As shown, the base 102 may be supported on the upper support surface 160 and fastened to the toilet unit 124 in any suitable manner. The cartridge 104 is removably connectable to the base 102, and includes a plurality of peel-off seating layers 150. Each peel-off seating layer 150 is independently removable from the other peel-off seating layers 150 for disposal. As exemplified, each peel-off seating layer 150 includes an upper seating surface 168 sized to support a user seated over the upper opening 164 of the lower bowl 114. As shown in FIG. 1, the toilet seat system 100 defines a passage 172 for human waste from a user seated on a peel-off seating layer 150 into the lower bowl 114 of the toilet unit 124.

Although the invention has been described with reference to certain specific embodiments, various modifications thereof will be apparent to those skilled in the art without departing from the spirit and scope of the invention.

1. A toilet comprising:
a toilet unit having a lower bowl, the lower bowl having an upper support surface defining an upper opening sized to receive human waste from a user seated over the upper opening; and
a toilet seat system including
a base overlying the upper support surface and fastened to the toilet unit, and
a cartridge removably connected to the base, the cartridge including a plurality of peel-off seating layers, each peel-off seating layer being independently separable from the other peel-off seating layers for disposal, each peel-off seating layer including an outwardly extending removal tab, and each peel-off seating layer including an upper seating surface sized to support a user seated over the upper opening.

2. The toilet of claim 1, wherein:
the cartridge overlies the base, and the cartridge is held spaced apart from the lower bowl by the base.

3. The toilet of claim 1, wherein:
the base has a base upper surface, and
the cartridge overlies the entirety of the base upper surface.

4. The toilet of claim 1, wherein:
the base includes a lock that removably connects the cartridge to the base, and
the lock has a locked position in which the cartridge is secured to the base, and an unlocked position in which the cartridge is removable from the base.

5. The toilet of claim 1, wherein:
the base includes a base upper surface having at least one of a base groove or a base ridge, and
the cartridge includes a cartridge lower surface having at least one of a cartridge groove or a cartridge ridge that mates with the base ridge or base groove when the cartridge is connected to the base.

6. The toilet of claim 1, wherein:
the base is supported on the upper support surface.

7. The toilet of claim 1, wherein:
the toilet unit further comprises a toilet seat overlying the upper support surface, and
the base is supported on the toilet seat.

8. The toilet of claim 7, wherein:
the base includes at least one fastener connecting the base to the toilet seat.

9. The toilet of claim 8, wherein:
the at least one fastener includes adhesive.

10. A toilet seat system for a toilet unit, the toilet unit having a lower bowl, the lower bowl having an upper support surface defining an upper opening sized to receive human waste from a user seated over the upper opening, the toilet system comprising:
a base sized to overlie the upper support surface of the lower bowl of the toilet unit, and
a cartridge removably connected to the base, the cartridge including a plurality of peel-off seating layers, each peel-off seating layer being independently separable from the other peel-off seating layers for disposal, each peel-off seating layer including an outwardly extending removal tab, and each peel-off seating layer including an upper seating surface sized to support a user seated over the upper opening of the lower bowl of the toilet unit,
wherein the base and cartridge define a passage for human waste from a user seated on a peel-off seating layer into the lower bowl of the toilet unit.

11. The toilet seat system of claim 10, wherein:
the base has a base upper surface, and
the cartridge overlies the entirety of the base upper surface.

12. The toilet seat system of claim 10, wherein:
the base includes a lock that removably connects the cartridge to the base, and
the lock has a locked position in which the cartridge is secured to the base, and an unlocked position in which the cartridge is removable from the base.

13. The toilet seat system of claim 10, wherein:
the base includes a base upper surface having at least one of a base groove or a base ridge, and
the cartridge includes a cartridge lower surface having at least one of a cartridge groove or a cartridge ridge that mates with the base ridge or base groove when the cartridge is connected to the base.

14. A method of sanitizing a toilet, the method comprising:
connecting a cartridge to a base, the cartridge including a plurality of peel-off seating layers, each peel-off seating layer independently separable from the other peel-off seating layers for disposal, each peel-off seating layer including an outwardly extending removal tab, the base connected to a toilet unit over an upper opening of a lower bowl of the toilet unit; and
pulling the removal tab to remove a topmost peel-off seating layer of the plurality of peel-off seating layers from the cartridge.

15. The method of claim 14, wherein:
connecting the cartridge to the base comprises mating a base groove or base ridge with a cartridge ridge or cartridge groove.

16. The method of claim 14, further comprising:
removing the cartridge from the base, and
replacing the cartridge with a new cartridge having a plurality of peel-off seating layers, each peel-off seating layer independently separable from the other peel-off seating layers for disposal, each peel-off seating layer including an outwardly extending removal tab.

17. The method of claim 16, wherein:
removing the cartridge from the base comprises moving a lock to an unlocked position to release the cartridge from the base.

18. The method of claim 14, wherein:
the base is fastened to a toilet seat overlying the upper opening.
